(19) United States
(12) Patent Application Publication
(10) Pub. No.: US 2015/0228015 A1
(43) Pub. Date: Aug. 13, 2015

(54) METHODS AND SYSTEMS FOR ANALYZING FINANCIAL DATASET

(71) Applicant: Xerox Corporation, Norwalk, CT (US)

(72) Inventors: Sakyajit Bhattacharya, Bangalore (IN); Vaibhav Rajan, Bangalore (IN)

(73) Assignee: Xerox Corporation, Norwalk, CT (US)

(21) Appl. No.: 14/179,775

(22) Filed: Feb. 13, 2014

(51) Int. Cl. G06Q 40/02

(52) U.S. Cl. CPC G06Q 40/025

(57) ABSTRACT

Disclosed are the embodiments for creating a model capable of identifying one or more clusters in a financial data. An input is received pertaining to a range of numbers. Each number in the range of numbers is representative of a number of clusters in the financial data. For a cluster, one or more first parameters of a distribution associated with the cluster are estimated. Thereafter, a threshold value is determined based on the one or more first parameters. An inverse cumulative distribution of each of one or more n-dimensional variables in the financial data is determined. The one or more first parameters are updated to generate one or more second parameters based on the estimated inverse cumulative distribution. A model is created for each number in the range of numbers based on the one or more second parameters.

### TECHNICAL FIELD

The presently disclosed embodiments are related, in general, to data mining. More particularly, the presently disclosed embodiments are related to methods and systems for creating a model capable of determining one or more clusters in a financial dataset.

### BACKGROUND

Financial data may correspond to a log that includes information pertaining to the monetary transactions. In an embodiment, the financial data may vary with the application area from which the data has been obtained. For instance, the financial data corresponding to bank statements of a customer may be different from financial data corresponding to monetary transaction of a large organization/government. In an embodiment, analyzing different types of financial data may derive different observations. In order to analyze the financial data, patterns in the financial data need to be determined.

Data mining involves determination of one or more patterns in a dataset, which may be used for various purposes such as, but not limited to, artificial intelligence, machine learning, and business intelligence. Such patterns may be used to determine clusters in the dataset. Clustering is a process of grouping a set of records in the dataset based on pre-defined characteristics associated with the set of records. Some of the commonly known clustering algorithms include, but are not limited to, k-means clustering, density-based clustering, centroid-based clustering, Gaussian mixture models, etc.

A Gaussian mixture model is a clustering technique that assumes that the dataset includes one or more components or clusters and data in each cluster is normally distributed (i.e., Gaussian distribution). In order to train the Gaussian mixture model, an input pertaining to a number of clusters present in the dataset is received from a user. As discussed above, data in each cluster is normally distributed. Parameters, such as mean and covariance, of the distribution for each cluster can be estimated using expectation-maximization algorithm. In an embodiment, the expectation-maximization algorithm includes determination of a likelihood that a data point or a record corresponds to a cluster. The likelihood is maximized and the parameters of the distribution that lead to the maximized likelihood are selected. The selected parameters are utilized to generate the Gaussian mixture model.

As it is assumed that the data in the clusters is normally distributed, Gaussian mixture models cannot be applied to scenarios where the data is not normally distributed.

### SUMMARY

According to embodiments illustrated herein there is provided a method for categorizing one or more customers in one or more categories based on a financial data associated with each of the one or more customers. The financial data includes a financial statement of each of the one or more customers. The method comprising receiving, by one or more processors, an input pertaining to a range of numbers. Each number corresponds to a number of categories in the financial data. Each category corresponds to a credit risk associated with each of the one or more customers. For a category in the number of categories one or more first parameters of a distribution associated with the category are estimated. An inverse cumulative distribution of one or more financial parameters associated with the financial statement of the one or more customers are estimated based on a threshold value and a cumulative distribution of each of the one or more financial parameters associated with the financial statement. The one or more first parameters are updated to generate one or more second parameters based on the estimated inverse cumulative distribution, wherein the updating is performed using an expectation-maximization algorithm. The method further comprises creating, by the one or more processors, a model for each number in the range of numbers based on the one or more second parameters associated with each category in the number of categories. A best model is selected from the model created for each number in the range of numbers using Bayesian information criteria. The best model is deterministic of the number of categories in the financial data. The best model categorizes each of the one or more customers listed in the financial data in one or more categories.

According to embodiment illustrated herein there is provided a system for categorizing one or more customers in one or more categories based on a financial data associated with each of the one or more customers. The financial data includes a financial statement of each of the one or more customers. The system comprising one or more processors configured to receive an input pertaining to a range of numbers. Each number corresponds to a number of categories in the financial data. Each category corresponds to a credit risk associated with each of the one or more customers. For a category in the number of categories one or more first parameters of a distribution associated with the category are estimated. The one or more processors are configured to estimate an inverse cumulative distribution of one or more financial parameters associated with the financial statement of the one or more customers based on a threshold value and a cumulative distribution of each of the one or more financial parameters associated with the financial statement. The one or more first parameters are updated to generate one or more second parameters based on the estimated inverse cumulative distribution. The updating is performed using an expectation-maximization algorithm. A model is created for each number in the range of numbers based on the one or more second parameters associated with each category in the number of categories. A best model is selected from the model created for each number in the range of numbers using Bayesian information criteria. The best model is deterministic of the number of categories in the financial data. The best model categorizes each of the one or more customers listed in the financial data in one or more categories.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not limit, the scope in any manner, wherein similar designations denote similar elements, and in which:

FIG. 1 is a flowchart illustrating a method for creating a model capable of identifying one or more clusters in a multivariate dataset;

FIG. 2 is a flow diagram illustrating creation of the model, in accordance with at least one embodiment;

FIG. 3 is a block diagram of a computing device that is capable of creating the model, in accordance with at least one embodiment; and

FIG. 4 is a flowchart illustrating a method for categorizing one or more customers in one or more categories based on a credit risk associated with each of the one or more customers, in accordance with at least one embodiment.

### DETAILED DESCRIPTION

The present disclosure is best understood with reference to the detailed figures and descriptions set forth herein. Various embodiments are discussed below with reference to the figures. However, those skilled in the art will readily appreciate that the detailed descriptions given herein with respect to the figures are simply for explanatory purposes, as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment,” “at least one embodiment,” “an embodiment,” “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the respective meanings set forth below.

“Multivariate dataset” refers to a dataset that includes observations of a p-dimensional variable. For example, ‘n’ realizations of p-dimensional variable may constitute a multivariate dataset. For example, a medical record data may include a measure of one or more physiological parameters of one or more patients. Such medical record data is an example of the multivariate dataset.

“Financial data” refers to a multivariate dataset that includes information pertaining to the monetary transactions in an organization. In an embodiment, the financial data may vary from the application area from which the data has been obtained. For instance, the financial data corresponding to bank statements of a customer may be different from financial data corresponding to monetary transaction of a large organization/government. For example, the financial data may correspond to bank transaction history of a person.

“Gaussian Mixture Model (GMM)” refers to a mathematical model that is capable of identifying one or more clusters in the multivariate dataset. In an embodiment, the data values in each of the one or more clusters are normally distributed (i.e., Gaussian distribution).

“Gaussian Copula Mixture Model (GCMM)” refers to a mathematical model that is capable of identifying one or more clusters in the multivariate dataset, where data values in each of the one or more clusters are distributed according to a Gaussian copula distribution.

A “cumulative distribution” refers to a distribution function, that describes the probability that a real-valued random variable X with a given probability distribution will be found at a value less than or equal to x.

An “inverse cumulative distribution” refers to an inverse function of the cumulative distribution of the random variable X.

A “mixing proportion of clusters” refers to a probability that a data value in the multivariate dataset belongs to different clusters. For example, the multivariate data includes two clusters. A probability that a data value in the multivariate data set belongs to the first cluster is 0.6. Then the probability that the data value will belong to the second cluster is 0.4. In an embodiment, the sum of probability of the data value in each of the one or more clusters in the dataset is one.

A “latent variable” refers to an intermediate variable that is not obtained from the multivariate dataset. In an embodiment, the latent variable is determined based on the one or more parameters.

“Probability” shall be broadly construed, to include any calculation of probability; approximation of probability, using any type of input data, regardless of precision or lack of precision; any number, either calculated or predetermined, that simulates a probability; or any method step having an effect of using or finding some data having some relation to a probability.

As discussed, the Gaussian mixture models are utilized for determining one or more clusters in a dataset. In order to determine the clusters, the Gaussian mixture models assume that data points in a cluster are normally distributed. In an embodiment, in most of the applications, the data points may not be normally distributed. Therefore, the Gaussian mixture models may not be able to predict the clusters in the dataset accurately.

In an embodiment, a Gaussian copula mixture model (GCMM) is another mathematical model that is utilized for identifying one or more clusters in a multivariate dataset. In an embodiment, the multivariate dataset may include data values of one or more p-dimensional variables. Each data value for each of the one or more p-dimensional variables may be a part of a cluster in the multivariate dataset. In an embodiment, the GCMM assumes that the data values in the cluster are derived from a Gaussian copula distribution. In an embodiment, copula corresponds to a multivariate probability distribution, for which marginal probability of each variable is uniformly distributed. In an embodiment, copulas are used for describing dependence between the one or more p-dimensional variables in the dataset. A typical Gaussian copula mixture model (GCMM) is represented by the following equation:

$$G C M M = \frac{{Σ}_{g = 1}^{G} {π}_{g} φ ( {y}_{i} \vert {μ}_{g} , {Σ}_{g} )}{{\prod }_{j = 1}^{p} {ψ}_{j} ( {y}_{i , j} )} \qquad ( 1 )$$

where,

yᵢ: Inverse cumulative distribution of p-dimensional random variable x;

p: Number of dimensions of random variable;

π_{g}: Mixing proportion of a cluster g with respect to other clusters in the multivariate dataset;

ψⱼ(y_{i,j}): Marginal density of GMM along j^{th} dimension;

G: Number of clusters in the multivariate dataset;

μ_{g}: Mean of the Gaussian copula mixture component g;

Σ_{g}: Covariance matrix of p-dimensional variable x (representative of a covariance between the one or more clusters); and

φ(yᵢ|μ_{g},Σ_{g}): Multivariate Gaussian distribution of the data values in a cluster g with mean μ_{g} and variance as Σ_{g}.

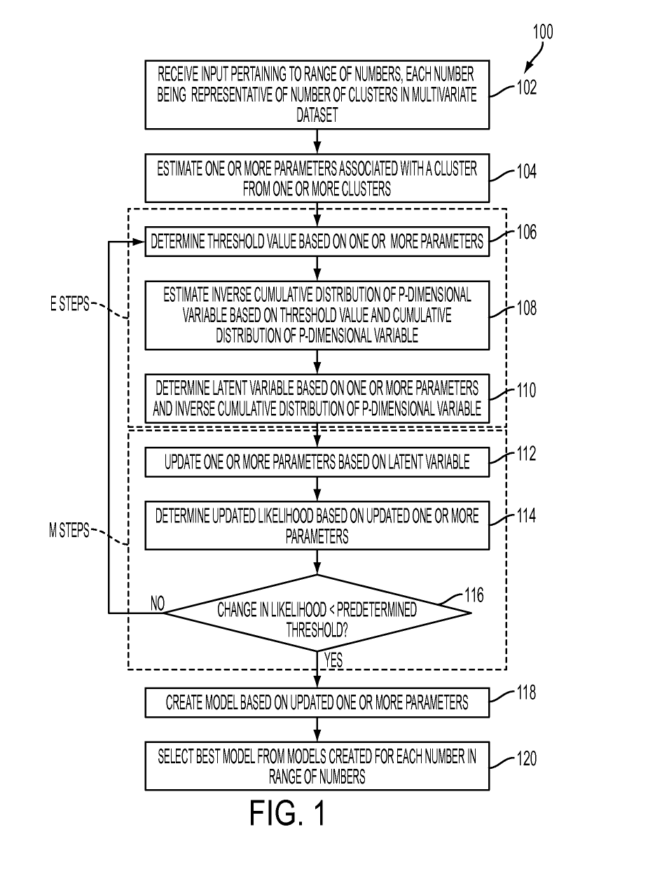

In order to determine a number of clusters in the multivariate dataset and classify each data value of the one or more p-dimensional random variables, a GCMM is created. The creation of the GCMM, in an embodiment of the disclosure, has been described in conjunction with FIG. 1.

FIG. 1 is a flowchart 100 illustrating a method for creating a model capable of identifying one or more clusters in a multivariate dataset. In an embodiment, the model is a Gaussian copula mixture model (GCMM).

At step 102, an input is received from a user. In an embodiment, the input corresponds to a range of numbers. In an embodiment, the range of numbers corresponds to a number of GCM models that are to be created. Additionally, in an embodiment, each number in the range of numbers corresponds to a probable number of clusters that may be present in the multivariate dataset. For example, if the user inputs the range as 1 to 3, then, three GCM models will be created for each number in the range (i.e., 1, 2, and 3). Further, each number (i.e., 1, 2, and 3) is representative of the number of clusters in the multivariate dataset. For instance, for the number 3, in the range of numbers, the multivariate dataset may include three clusters. In an embodiment, the GCM models created for a particular number in the range of numbers will be able to identify that particular number of clusters in the multivariate dataset. For instance, the GCM model created for the number 3, in the range of numbers, will be able to identify three clusters in the multivariate dataset.

In addition, the multivariate dataset is received from the user. The multivariate dataset includes data values pertaining to a p-dimensional variable in the multivariate dataset. Hereinafter, the term data value has been interchangeably referred as realization. For the purpose of ongoing description, n realizations of the p-dimensional variable are present in the multivariate dataset.

At step 104, one or more parameters associated with a cluster from one or more clusters are estimated. Prior to determining the one or more parameters, a number is sequentially selected from the range of numbers. In an embodiment, the number corresponds to the number of clusters in the one or more clusters. For each cluster in the one or more clusters, the one or more parameters are determined. In an embodiment, the one or more parameters may include, but are not limited to, a mixing proportion of the one or more clusters, a mean of the distribution of the cluster (i.e., Gaussian copula mixture), a covariance between the one or more clusters. In an embodiment, the one or more parameters are estimated randomly. In an alternate embodiment, the one or more parameters are estimated using a k-means clustering algorithm. In an embodiment, the k-means clustering algorithm estimates the one or more parameters based on the following constraints:

π_{g}>0 (2)

Σ_{g=1}^{G}π_{g}=1 (3)

Σ_{g} is positive and definite (4)

δᵢ=Min_{g,j}|y_{i,j}⁽⁰⁾−2κ⁽⁰⁾([[Σ_{g}⁽⁰⁾⁺1]⁻¹Σ_{g}⁽⁰⁾I)ⱼ| (5)

where,

π_{g}: Mixing proportions of the one or more clusters;

Σ_{g}: Covariance between the one or more clusters;

G: Number of clusters in the multivariate dataset;

u_{i,j}⁽⁰⁾: Inverse cumulative distribution of the p-dimensional variable along the j^{th} dimension; and

κ⁽⁰⁾: Max(μ_{g,ij}), where μ_{g,ij} corresponds to mean of the distribution of the cluster g along the j^{th} dimension.

A person having ordinary skill in the art would understand that the scope of the disclosure is not limited to estimating the one or more parameters using the k-means clustering algorithm. In an embodiment, any other technique such as decision tree and Gaussian mixture model may be used for estimating the one or more parameters.

At step 106, a threshold value is determined based on the one or more parameters. In an embodiment, the following equation is utilized to determine the threshold value:

$$Γ = {{κ}^{( t )} ( {[ {S}^{( t )} + I ]}^{- 1} {S}^{( t )} I )}_{j} + \frac{1}{2} ( 1 + \frac{{m}^{( t )}}{p} ) {δ}_{i} \qquad ( 6 )$$

where,

Γ: Threshold value;

S^{(t)}=Σ_{g=1}^{G}z_{ig}^{(t-1)}Σ_{g}^{(t)} (7)

where

z_{ig} corresponds to a latent variable;

m^{(t)}: Sum of all elements of S^{(t)}.

In an embodiment, the latent variable corresponds to an intermediate variable that is not obtained from the multivariate dataset. In an embodiment, the latent variable is determined based on the one or more parameters. The determination of the latent variable, in an embodiment of the disclosure, has been described later.

At step 108, an inverse cumulative distribution of the p-dimensional variable is determined based on the threshold value (determined in the step 106) and the cumulative distribution of the p-dimensional variable. In an embodiment, the following equations are utilized to determine the inverse cumulative distribution:

$$\begin{matrix}{y}_{ij} = {( {Σ}_{g = 1}^{G} \frac{{π}_{g}^{( t )}}{{σ}_{g , ij}^{( t )}} )}^{- 1} [ {u}_{ij} + \frac{1}{\sqrt{2 Π}} {Σ}_{g = 1}^{G} \frac{{π}_{g}^{( t )} {μ}_{gj}^{( t )}}{{σ}_{g , jj}^{( t )}} - \frac{1}{2} ] & ( 8 ) \\ {y}_{ij} = Max ( {y}_{ij} , Γ ) & ( 9 )\end{matrix}$$

where,

yᵢⱼ: Inverse cumulative distribution of the p-dimensional variable along j^{th} dimension;

σ_{g,jj}^{(t)}: j^{th} diagonal element of the covariance matrix of the g-th cluster.

In an embodiment, the threshold value Γ is a lower bound value for the inverse cumulative distribution of the p-dimensional variable. If at any instance, the determined value of the inverse cumulative distribution yᵢⱼ is less than the threshold value Γ, the threshold value Γ is selected as the value of the inverse cumulative distribution yᵢⱼ.

A person having ordinary skill in the art would understand that initially, when the one or more parameters are estimated using the k-means algorithm, the inverse cumulative distribution is determined based on the initial one or more parameters. In addition, based on the initial estimate of the inverse cumulative distribution, an initial likelihood is determined. In an embodiment, the initial likelihood corresponds to a probability that the initial one or more parameters are deterministic of the GCM model. In an embodiment, the initial likelihood is determined using the following equation:

$$Inital likelihood = {Σ}_{i = 1}^{n} log {Σ}_{g = 1}^{G} {π}_{g} \frac{{Σ}_{g = 1}^{G} {π}_{g} φ ( {y}_{i} \vert {μ}_{g} , {Σ}_{g} )}{{\prod }_{j = 1}^{p} {ψ}_{j} ( {y}_{i , j} )} \qquad ( 10 )$$

At step 110, the latent variable is determined based on the one or more parameters and the inverse cumulative distribution of the p-dimensional variable (determined in step 108). In an embodiment, the latent variable is determined using the following equation:

$${z}_{ig}^{( t )} = \frac{{π}_{g}^{( t )} φ ( {y}_{i}^{( t )} \vert {μ}_{g}^{( t )} , {Σ}_{g}^{( t )} )}{{Σ}_{g = 1}^{G} {π}_{g}^{( t )} φ ( {y}_{i}^{( t )} \vert {μ}_{g}^{( t )} , {Σ}_{g}^{( t )} )} \qquad ( 11 )$$

At step 112, the one or more parameters are updated based on the determined latent variable. In an embodiment, the one or more parameters are updated using following equations:

$$\begin{matrix}{π}_{g}^{( t + 1 )} = \frac{{Σ}_{i = 1}^{n} {z}_{ig}^{( t )}}{n} & ( 12 ) \\ {μ}_{g}^{( t + 1 )} = \frac{{Σ}_{i = 1}^{n} {z}_{ig}^{( t )} {y}_{i}^{( t )}}{{Σ}_{i = 1}^{n} {z}_{ig}^{( t )}} & ( 13 ) \\ {Σ}_{g}^{( t + 1 )} = \frac{{Σ}_{i = 1}^{n} {{z}_{ig}^{( t )} ( {y}_{i}^{( t )} - {μ}_{g}^{( t + 1 )} )}^{T} ( {y}_{i}^{( t )} - {μ}_{g}^{( t + 1 )} )}{{Σ}_{i = 1}^{n} {z}_{ig}^{( t )}} & ( 14 )\end{matrix}$$

At step 114, an updated likelihood is determined based on the updated one or more parameters. In an embodiment, the updated likelihood is determined using the following equation:

$${L}^{( t + 1 )} = {Π}_{i = 1}^{n} {Σ}_{g = 1}^{G} {π}_{g}^{( t + 1 )} \frac{1}{\sqrt{det ( 2 {πΣ}_{g}^{( t + 1 )} )}} exp ( - \frac{1}{2} {( {y}_{i}^{( t )} - {μ}_{g}^{( t + 1 )} )}^{T} {Σ}_{g}^{{( t + 1 )}^{- 1}} ( {y}_{i}^{( t )} - {μ}_{g}^{( t + 1 )} ) ) \qquad ( 15 )$$

At step 116, a check is performed to determine whether a difference between the updated likelihood and the previous likelihood is less than a predefined threshold. In an embodiment, the previous likelihood corresponds to a likelihood that was determined in the previous iteration. For instance, during the first iteration of the method, the likelihood determined for the first iteration (t=1) is compared with the initial likelihood determined using equation 10. In a similar manner, in each iteration, the likelihood determined using the updated one or more parameters, for that iteration, is compared with the likelihood that was determined in the previous iteration. In an embodiment, the following equation is used to perform the check:

L^{(t+1)}−L^{(t)}<ε (16)

where,

L^{(t+1)}: Updated likelihood determined using the updated one or more parameters;

L^{(t)}: Likelihood determined in the previous iteration; and

ε: Predefined threshold.

If at step 116 it is determined that the difference is greater than the predefined threshold, steps 106-116 are repeated. However, if at step 116 it is determined that the difference is less than the predefined threshold, the updated one or more parameters are considered as the parameters of the model.

At step 118, a model is created based on the updated one or more parameters. In an embodiment, the following equation represents the model:

GCM model=Πᵢ₌₁ⁿ²Σ_{g=1}^{G}π_{g}Πᵢ₌₁ⁿ[C((uᵢ₁, . . . ,uᵢₚ)ν)Πⱼ₌₁^{p}f_{J}(xᵢⱼ)] (17)

where,

uᵢₚ: Cumulative distribution of the p-dimensional variable;

C: Copula function (represented by equation 1) of the p-dimensional variable;

f_{J}(xᵢⱼ): Joint distribution of the p-dimensional variable; and

ν: Vector of the one or more parameters.

In an embodiment, the steps 104-118 are repeated for each number in the range of numbers, to create the model for each number in the range of numbers. Thus, the number of models that will be created is equal to the range of numbers.

At step 120, a best model is selected from the model created for each number in the range of numbers. In an embodiment, the best model is selected using Bayesian Information Criterion (BIC). In order to determine the best model, a score is determined for each model created for the numbers in the range of numbers. In an embodiment, the following equation is used for determining the score:

BIC score=2 log L(\hat{v}(uᵢ₁, . . . ,uᵢₚ))−ρ log n (18)

where,

\hat{v}: The one or more updated parameters that are used for creating the model in step 118;

L: The likelihood estimated (using equation 15) for the one or more updated parameters, which are used for creating the model in step 118;

ρ: Number of free parameters; and

n: Number of data values or realizations.

In an embodiment, the free parameters correspond to parameters that do not depend on the one or more parameters or the multivariate dataset. The free parameters are determined independently. In an embodiment, the number of free parameters for p-dimensional data and G clusters is determined using the following equation:

ρ=(G−1)+Gp+Gp(p+1)/2 (19)

In an embodiment, the model that has the best BIC score is selected as the best model. Further, in an embodiment, the number (from the range of numbers), for which the best model is created, corresponds to the number of clusters present in the multivariate dataset. For example, if the range of numbers is 1-3, three models will be created, one for each number, i.e., 1, 2, and 3. Further, if the model created for the number 2 has the maximum BIC score, the second model, which corresponds to the number 2, is selected. Additionally, in this case, the number of clusters that will be present in the multivariate dataset is two.

A person having ordinary skill in the art would understand that the number of clusters determined in step 120 is an estimate of the number of clusters present in the multivariate dataset. In an embodiment, the multivariate dataset may include more than the estimated number of clusters.

In an embodiment, the models created for each number in the range of numbers are mixture models. In an embodiment, the mixture model corresponds to a probabilistic model that has the capability of identifying one or more clusters in the multivariate dataset. Post selection of the best model, the best model is used to categorize each data point (realization of the p-dimensional variable) in the multivariate dataset into the one or more clusters.

In an embodiment, the method described in the flowchart 100 corresponds to an Expectation-Maximization (EM) algorithm. Each iteration of the EM algorithm alternates between performing a set of expectation (E) steps, which create a function for the expectation of the log-likelihood evaluated using the current estimate for the parameters (determination of the latent variable), and a set of maximization (M) steps, which compute the parameters maximizing the expected log-likelihood found in the E steps. In an embodiment, steps 106, 108, and 110 correspond to the E steps of the EM algorithm, while steps 112, 114, and 116 correspond to the M steps of the EM algorithm.

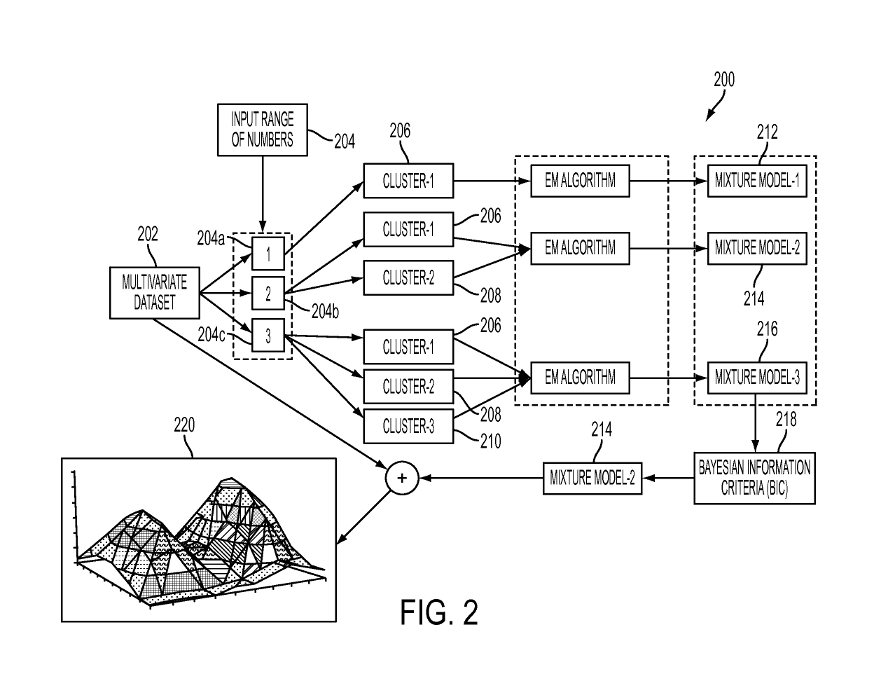

FIG. 2 is a flow diagram 200 illustrating creation of the model, in accordance with at least one embodiment. The flow diagram 200 has been described in conjunction with FIG. 1.

The multivariate dataset (depicted by 202) is received from the user. In addition, the range of numbers (depicted by 204) is received from the user. For instance, the range of number include (1 (depicted by 204a), 2 (depicted by 204b), and 3 (depicted by 204c)). As discussed above, each number corresponds to a probable number of clusters present in the multivariate dataset 202. For instance, for the number 1 (depicted by 204a), it is assumed that the multivariate dataset 202 includes only one cluster (i.e., cluster-1 (depicted by 206)). Similarly, for the number 2 (depicted by 204b), it is assumed that the multivariate dataset 202 includes two clusters (i.e., cluster-1 (depicted by 206) and cluster-2 (depicted by 208)). Further, for the number 3 (depicted by 204c), in the range of numbers (depicted by 204), it is assumed that the multivariate dataset 202 includes a third cluster (cluster-3 (depicted by 210)) in addition to the two clusters 206 and 208. For each number in the range of numbers, the EM algorithm is executed. In an embodiment, the EM algorithm estimates the one or more parameters of a mixture model capable of clustering the data points into the one or more clusters, where the number of clusters is determined based on the number in the range of numbers. For example, the EM algorithm executed for the cluster-1 (depicted by 206) will generate the mixture model-1 212 that will be able to cluster the data values in the multivariate dataset 202 in the cluster-1 (depicted by 206). Similarly, the mixture model-2 (depicted by 214) is generated for the number 2 (depicted by 204b). The mixture model-2 (depicted by 214) will be able to cluster the data values in the two clusters (i.e., cluster-1 (depicted by 206) and cluster-2 (depicted by 208)).

Post creation of the mixture models for each number in the range of numbers, a BIC score is determined for each mixture model using equation 18 (depicted by 218). For instance, if the mixture model-2 (depicted by 214) has the maximum BIC score, the mixture model-2 (depicted by 214) is selected. Further, as the mixture model-2 (depicted by 214) has been obtained for the number 2 (depicted by 204b) in the range of numbers (depicted by 204), the number of probable clusters in the multivariate dataset 202 are two. Post selection of the mixture model-2 (depicted by 214), the mixture model-2 (depicted by 214) is used for clustering (depicted by 220) the multivariate dataset 202.

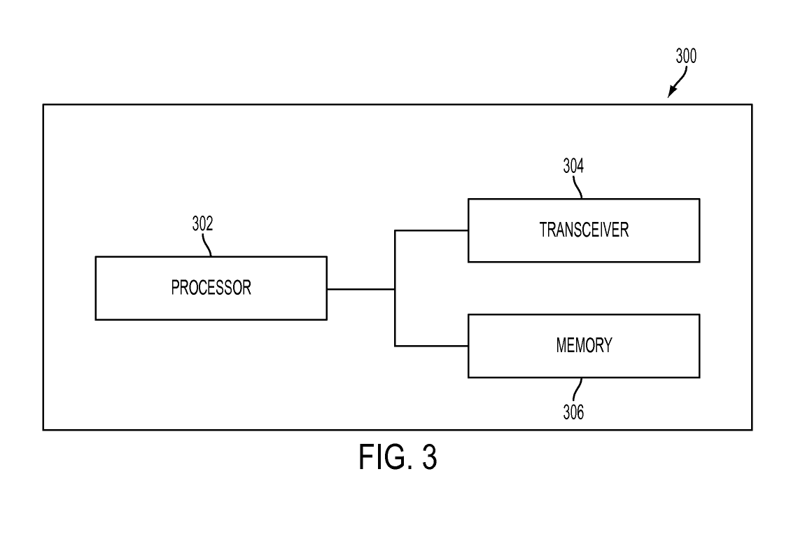

FIG. 3 is a block diagram of a computing device 300 that is capable of creating the model, in accordance with at least one embodiment. The computing device 300 includes a processor 302, a transceiver 304, and a memory 306. The processor 302 is coupled to the transceiver 304 and the memory 306.

The processor 302 includes suitable logic, circuitry, and interfaces and is configured to execute one or more instructions stored in the memory 306 to perform predetermined operations on the computing device 300. The memory 306 may be configured to store the one or more instructions. The processor 302 may be implemented using one or more processor technologies known in the art. Examples of the processor 302 include, but are not limited to, an X86 processor, a RISC processor, an ASIC processor, a CISC processor, or any other processor.

The transceiver 304 transmits and receives messages and data. Further, the transceiver is capable of receiving the multivariate dataset and the range of numbers from the user. Examples of the transceiver 304 may include, but are not limited to, an antenna, an Ethernet port, a universal serial bus (USB) port, or any other port that can be configured to receive and transmit data. The transceiver 304 transmits and receives data and messages in accordance with various communication protocols, such as, TCP/IP, UDP, and 2G, 3G, or 4G communication protocols.

The memory 306 stores a set of instructions and data. Some of the commonly known memory implementations include, but are not limited to, a RAM, a read-only memory (ROM), a hard disk drive (HDD), and a secure digital (SD) card. Further, the memory 306 includes the one or more instructions that are executable by the processor 302 to perform specific operations. It is apparent to a person having ordinary skill in the art that the one or more instructions stored in the memory 306 enable the hardware of the computing device 300 to perform the predetermined operations. In an embodiment, the computing device 300 is configured to execute the flowchart 100 to generate the model that is capable of identifying the one or more clusters in the multivariate dataset.

In an embodiment, the method described in the flowchart 100 can be utilized to determine the one or more clusters in the financial data. For the purpose of forgoing description, the financial data considered corresponds to loan risk assessment data. However, a person having ordinary skill in the art would understand that the scope of the disclosure is not limited to loan risk assessment data. In an embodiment, the financial data may correspond to various other types of data such as, but are not limited to, insurance data, bank statements, and bank transaction data.

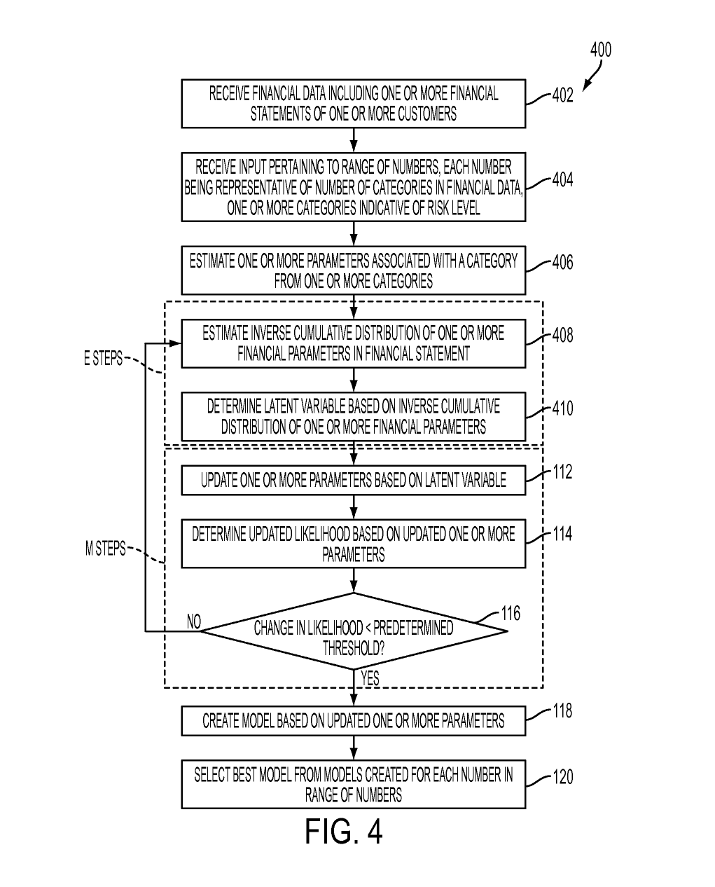

FIG. 4 is a flowchart 400 illustrating a method for categorizing one or more customers in one or more categories based on a credit risk associated with each of the one or more customers, in accordance with at least one embodiment.

At step 402, financial data is received from a user. In an embodiment, the processor 302 receives the financial data. In an embodiment, the financial data includes a financial statement of each of the one or more customers. In an embodiment, the financial statement may include one or more financial parameters such as, but is not limited to, age, credit amount, instalment rate, a percentage of disposable income. In an embodiment, the one or more financial parameters in the financial statement may correspond to the p-dimensional variable with age, credit amount, instalment rate, a percentage of disposable income as the different dimensions of the variable.

A person having ordinary skill in the art would understand that the scope of disclosure is not limited to aforementioned parameters of the financial statement. In an embodiment, various other parameters pertaining to the financial statement can be used.

At step 404, an input is received from the user pertaining to a range of numbers. In an embodiment, the processor 302 receives the input through the transceiver 304. In an embodiment, the range of numbers corresponds to probable levels of credit risk associated with each of the one or more customers. For example, the levels of credit risk may include, but are not limited to, good customers with 10% risk, bad customers with 90% associated risk, customers having 60% risk associated with them, etc.

At step 406, one or more parameters associated with a risk level from the one or more risk levels are estimated. In an embodiment, the processor 302 estimates the one or more parameters in a similar manner as described in the step 104.

At step 408, an inverse cumulative distribution of the one or more financial parameters associated with each of the one or more customers is estimated. In an embodiment, the processor 302 estimates the inverse cumulative distribution. Prior to estimating the inverse cumulative distribution, the processor 302 determines the threshold value, which is a lower bound for the inverse cumulative distribution of the one or more financial parameters. In an embodiment, the threshold value and the inverse cumulative distribution may be determined as described in the steps 106 and 108, respectively.

Based on the inverse cumulative distribution of the one or more financial parameters, an initial likelihood is determined by using the equation 10.

At step 410, a latent variable is determined based on the inverse cumulative distribution of the one or more financial parameters. In an embodiment, the processor 302 determines the latent variable. In an embodiment, the processor 302 performs the step 110 to determine the latent variable.

At step 112, the one or more parameters are updated based on the latent variable. In an embodiment, the processor 302 is configured to update the one or more parameters. At step 114, an updated likelihood is determined based on the updated one or more parameters. In an embodiment, the processor 302 determines the updated likelihood. At step 116, a check is performed to determine whether a difference between the update likelihood and the previous likelihood is less than a predefined threshold. If at step 116 it is determined that the difference is greater than the predefined threshold, 408-116 are repeated. However, if at step 116 it is determined that the difference is less than the predefined threshold, the updated one or more parameters are considered as the parameters of the model. Further, at step 118, a model is created based on the updated one or more parameters.

In an embodiment, the aforementioned steps are repeated for each number in the range of numbers. In an embodiment, the number of models created is equal to the total numbers present in the range of numbers. Further, at step 120, a best model is selected from the models created for the numbers in the range of numbers. In an embodiment, the number, from the range numbers, for which the best model is selected, represents the number of risk levels present in the financial data. For instance, if the best model was created for the number 4, the best model will be able to categorize the customers into four categories (e.g., good customers (0-10% risk), medium-good customer (11%-25% risk), medium bad customer (26%-75% risk), and bad customers (76-99% risk)). Post creation of the models and the selection of the best model, the selected model are used to categorize the one or more customers into four categories.

A person having ordinary skill in the art would understand that the scope of the disclosure is not limited to determining credit risk associated with one or more customers. In an embodiment, the various other patterns in the financial data can be determined, for instance, the customers can be segregated in one or more categories based on buying habits of the customer.

The disclosed embodiments encompass numerous advantages. The estimation of the inverse cumulative distribution of the p-dimensional variable enables the usage of the expectation maximization algorithm to generate the GCMM. Further, the number of clusters present in the multivariate dataset is also estimated. This enables the system to be more dynamic and provides adaptability. Suppose, the system receives an unknown multivariate dataset. The user may enter a range of numbers that he/she feels should be the number of clusters in the multivariate dataset. The system creates a model for each number and from the models so created a best model is selected. The number from the range of number that corresponds to the selected best model is representative of the number of clusters present in the multivariate dataset. This capability of estimating the number of clusters makes the system adaptive. Further, this adaptive system can be used to identify clusters in any multivariate dataset such as financial data or healthcare related data.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for analyzing financial dataset have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for categorizing one or more customers in one or more categories based on a financial data associated with each of the one or more customers, the financial data includes a financial statement of each of the one or more customers, the method comprising:
receiving, by one or more processors, an input pertaining to a range of numbers, wherein each number corresponds to a number of categories in the financial data, wherein each category corresponds to a credit risk associated with each of the one or more customers;
for a category in the number of categories:
estimating, by the one or more processors, one or more first parameters of a distribution associated with the category;
estimating, by the one or more processors, an inverse cumulative distribution of one or more financial parameters associated with the financial statement of the one or more customers based on a threshold value and a cumulative distribution of each of the one or more financial parameters associated with the financial statement;
updating, by the one or more processors, the one or more first parameters to generate one or more second parameters based on the estimated inverse cumulative distribution, wherein the updating is performed using an expectation-maximization algorithm;
creating, by the one or more processors, a model for each number in the range of numbers based on the one or more second parameters associated with each category in the number of categories; and
selecting, by the one or more processors, a best model from the model created for each number in the range of numbers using Bayesian information criteria, wherein the best model is deterministic of the number of categories in the financial data,
wherein the best model categorizes each of the one or more customers listed in the financial data in one or more categories.

2. The method of claim 1, wherein the one or more financial parameters associated with the financial statement comprise at least one of an age, a credit amount, an instalment rate, or a percentage of disposable income.

3. The method of claim 1, wherein the one or more financial parameters associated with the financial statement correspond to an n-dimensional variable.

4. The method of claim 1, wherein the distribution associated with the category corresponds to a Gaussian copula distribution.

5. The method of claim 1, wherein the expectation-maximization algorithm further comprises determining, by the one or more processors, a latent variable for the category, based on the one or more first parameters and the inverse cumulative distribution of the one or more financial parameters associated with the financial statement.

6. The method of claim 5, wherein the one or more first parameters are updated based at least on the latent variable.

7. The method of claim 1, wherein the expectation-maximization algorithm further comprises determining, by the one or more processors, a first likelihood of the one or more first parameters being deterministic of the model.

8. The method of claim 7, wherein the expectation-maximization algorithm further comprises determining, by the one or more processors, a second likelihood of the one or more second parameters being deterministic of the model.

9. The method of claim 8 further comprising comparing, by the one or more processors, the first likelihood and the second likelihood.

10. The method of claim 9, wherein the model is created using the one or more second parameters based on the comparison.

11. The method of claim 10, wherein the threshold value, and the inverse cumulative distribution are updated using the one or more second parameters based on the comparison.

12. The method of claim 11, wherein the one or more second parameters are updated using the updated threshold value and the updated inverse cumulative distribution based on the comparison, wherein the second likelihood is updated based on the updated one or more second parameters.

13. A system for categorizing one or more customers in one or more categories based on a financial data associated with each of the one or more customers, the financial data includes a financial statement of each of the one or more customers, the system comprising:
one or more processors configured to:
receive an input pertaining to a range of numbers, wherein each number corresponds to a number of categories in the financial data, wherein each category corresponds to a credit risk associated with each of the one or more customers;
for a category in the number of categories:
estimate one or more first parameters of a distribution associated with the category;
estimate an inverse cumulative distribution of one or more financial parameters associated with the financial statement of the one or more customers based on a threshold value and a cumulative distribution of each of the one or more financial parameters associated with the financial statement;
update the one or more first parameters to generate one or more second parameters based on the estimated inverse cumulative distribution, wherein the updating is performed using an expectation-maximization algorithm;
create a model for each number in the range of numbers based on the one or more second parameters associated with each category in the number of categories; and
select a best model from the model created for each number in the range of numbers using Bayesian information criteria, wherein the best model is deterministic of the number of categories in the financial data,
wherein the best model categorizes each of the one or more customers listed in the financial data in one or more categories.

14. The system of claim 13, wherein the one or more financial parameters associated with the financial statement comprise at least one of an age, a credit amount, an installment rate, or a percentage of disposable income.

15. The system of claim 13, wherein the one or more financial parameters associated with the financial statement correspond to an n-dimensional variable.

16. The system of claim 13, wherein the distribution associated with the category corresponds to a Gaussian copula distribution.

17. The system of claim 13, wherein the expectation-maximization algorithm further comprises determining, by the one or more processors, a latent variable for the category, based on the one or more first parameters and the inverse cumulative distribution of the one or more financial parameters associated with the financial statement.

18. The system of claim 17, wherein the one or more first parameters are updated based at least on the latent variable.

19. The system of claim 13, wherein the expectation-maximization algorithm further comprises determining, by the one or more processors, a first likelihood of the one or more first parameters being deterministic of the model.

20. The system of claim 19, wherein the expectation-maximization algorithm further comprises determining, by the one or more processors, a second likelihood of the one or more second parameters being deterministic of the model.

21. The system of claim 20 further comprising comparing, by the one or more processors, the first likelihood and the second likelihood.

22. The system of claim 21, wherein the model is created using the one or more second parameters based on the comparison.

23. The system of claim 22, wherein the threshold value, and the inverse cumulative distribution are updated using the one or more second parameters based on the comparison.

24. The system of claim 23, wherein the one or more second parameters are updated using the updated threshold value and the updated inverse cumulative distribution based on the comparison, wherein the second likelihood is updated based on the updated one or more second parameters.
